(19) United States
(12) Patent Application Publication
(10) Pub. No.: US 2009/0194552 A1
(43) Pub. Date: Aug. 6, 2009

(54) GOLF BALL DISPENSER

(76) Inventors: Stephen M. Jeremias, Montclair, NJ (US); William J. Milnazik, Berwyn, PA (US)

Correspondence Address: BLANK ROME LLP, WATERGATE, 600 NEW HAMPSHIRE AVENUE, N.W., WASHINGTON, DC, 20037, US

(21) Appl. No.: 12/023,626

(22) Filed: Jan. 31, 2008

(51) Int. Cl. A63B 57/00; B65G 59/02; A63B 47/00

(52) U.S. Cl. 221/14; 221/155; 221/154; 221/185; 221/271

(57) ABSTRACT

A golf ball container and dispenser for use in storing and dispensing golf balls is constructed of a tube, bottom, spring, spring pad, wire ball catch, opening, bag clip. The bottom is beveled to prevent damage to golf clubs contained in the golf bag and to the device itself. The bottom is also removably attached to facilitate cleaning and maintenance of the interior components of the device. The device may be freestanding or may be inserted in a receptacle molded into the interior of a golf bag to provide further protection from damage to golf clubs and other accessories contained therein as well as to the golf bag itself.

### BACKGROUND OF THE INVENTION

1. Field of Invention

The present invention relates generally to the field of golf equipment. More particularly, the invention relates to an elongated golf ball dispenser that may be freestanding, or alternatively fits in a golf bag, and allows easy access to golf balls stored within.

2. Description of Related Art

Throughout the course of a round of golf, it often becomes necessary for a golfer to replace the golf ball being played as a result of loss or damage. As a result, golfers are forced to carry several spare golf balls with them for the duration of the round. The spare balls are often kept in golf bags used by golfers to transport spare golf balls in addition to golf clubs and other golf and non-golf related paraphernalia during the course of a round of golf.

These golf bags, however, often provide only simple pockets in which spare golf balls are loosely stored among other things. As a result, when a golfer attempts to retrieve a spare golf ball from a golf bag upon losing or damaging the currently played ball, it is often inconveniently stored and difficult to find and obtain. As a result of the balls being stored loosely in pockets among other articles, it is easy for the balls to become damaged by or cause damage to these other articles when the objects are shifted around during transport. In addition, bending down to access the pockets can also be difficult, particularly for older golfers. Finally, it is not readily apparent to the golfer how many golf balls are stored in the various pockets of the golf bag.

Golf ball dispensers have become well known in the art. For example, U.S. Pat. No. 6,189,732 to Althaus et al. describes a Golf Ball Carrier and Dispenser in the form of a tube in which balls are stacked and biased to one end by spring action where an end opening smaller than the balls restrains the endmost ball from release. The patent further describes a side dispensing opening for release of a ball located adjacent to the end of the tube so that when pressure is applied through the end opening, the endmost ball of the stack can be pushed downwardly and toward the exit opening for release of the endmost ball over the next underlying ball in the stack.

U.S. Pat. No. 5,554,077 to Coles describes a similar device wherein the balls are restrained at the open end of the tube by a cap connected via a bridging member to the tube cylinder and projecting over the axial center line of the cylinder and formed with a concave spherical shape to receive the end of a ball contained within the dispenser.

However, there is a need for convenient access to the interior of the device both for purposes of inserting and removing golf balls and for cleaning and maintenance of the interior of the device. Use of the spherical cap connected to the tube via a bridging member as described in Coles, for example, restricts access to the topmost retained ball by, for example, preventing finger tip contact with the ball from any direction. There is also a need for a golf ball dispensing device having a removable bottom providing convenient access to the interior of the device for cleaning and maintenance, particularly of the spring mechanism. Finally, there is a need for a golf ball dispensing device that can be integrated into the interior of a golf bag.

### SUMMARY AND OBJECTS OF THE INVENTION

Accordingly, there exists a need for a device for storing and dispensing golf balls that allows for convenient access to the interior of the device for the purposes of inserting and removing golf balls and for cleaning and maintaining the interior of the device. Said device should be of simple construction and durable so as to resist damage. There also exists a need for a device for storing and dispensing golf balls that can be integrated into a golf bag in a manner that protects against damage to the device or to the contents of the golf bag or the golf bag itself.

Briefly described, those and other objects and features of the present invention are accomplished, as embodied and fully described herein, by a device that includes an elongated housing having an interior for receiving a plurality of golf balls in a linear configuration, the elongated housing having a first end and a second end opposite the first end; a cap removably engaging the first end of the elongated housing to permit access to the housing interior; a wire ball catch fixedly attached to the second end of the elongated housing for retaining a topmost golf ball of the plurality of golf balls at a position external to said interior; a spring having a bottom end engaging the cap at the first end of the elongated housing and a top end providing an upward force toward the second end of the elongated housing, said spring also having a spring stop for preventing the spring from becoming overly compressed; a spring pad engaging to the top end of the spring, said spring pad engaging a bottommost golf ball of the plurality of golf balls in a vertical configuration such that the upward force of the top end of the spring is applied to the bottom ball urging the plurality of golf balls toward the second end of the elongated housing; and an opening at the second end of the elongated housing for removing the topmost ball from the device.

The objects and features of the device also include a device with one or more vertical slots cut into the elongated housing providing visual access to the interior of the device.

The objects and features of the device also include a device wherein the bottom removably attached to the second end of the elongated housing is a beveled, threaded cap.

The objects and features of the device also include a device wherein said cap is threadably received on the first end of the elongated housing.

The objects and features of the device also include a device wherein the wire ball catch is curved to retain the topmost golf ball with minimal contact with the surface of the topmost ball and maximal accessibility to the topmost ball.

The objects and features of the device also include a device wherein said wire ball catch is a wire prong.

The objects and features of the device also include a device with a bag clip for removably attaching the device to a golf bag.

The objects and features of the device also include a device with a receptacle molded into the interior of a golf bag for slidably and removably receiving the housing.

With those and other objects, advantages and features of the invention that may become hereinafter apparent, the nature of the invention may be more clearly understood by reference to the following detailed description of the invention, the appended claims and to the several drawings attached herein.

### DESCRIPTION OF THE DRAWINGS

FIG. 1 depicts a side view of one embodiment of the present device;

FIGS. 2(a) and (b) depict a partial front and back view of the top portion of the present device;

FIG. 3 depicts a top view of the embodiment of the present device;

FIG. 4 depicts a cutaway view of the bottom portion of the present device;

FIGS. 5(a) and (b) depict a front and side view of the device as integrated into a golf bag; and

FIG. 6 depicts a top view of the device as integrated into a golf bag.

### DETAILED DESCRIPTION OF THE PREFERRED EMBODIMENT

Several preferred embodiments of the invention are described for illustrative purposes, it being understood that the invention may be embodied in other forms not specifically shown in the drawings.

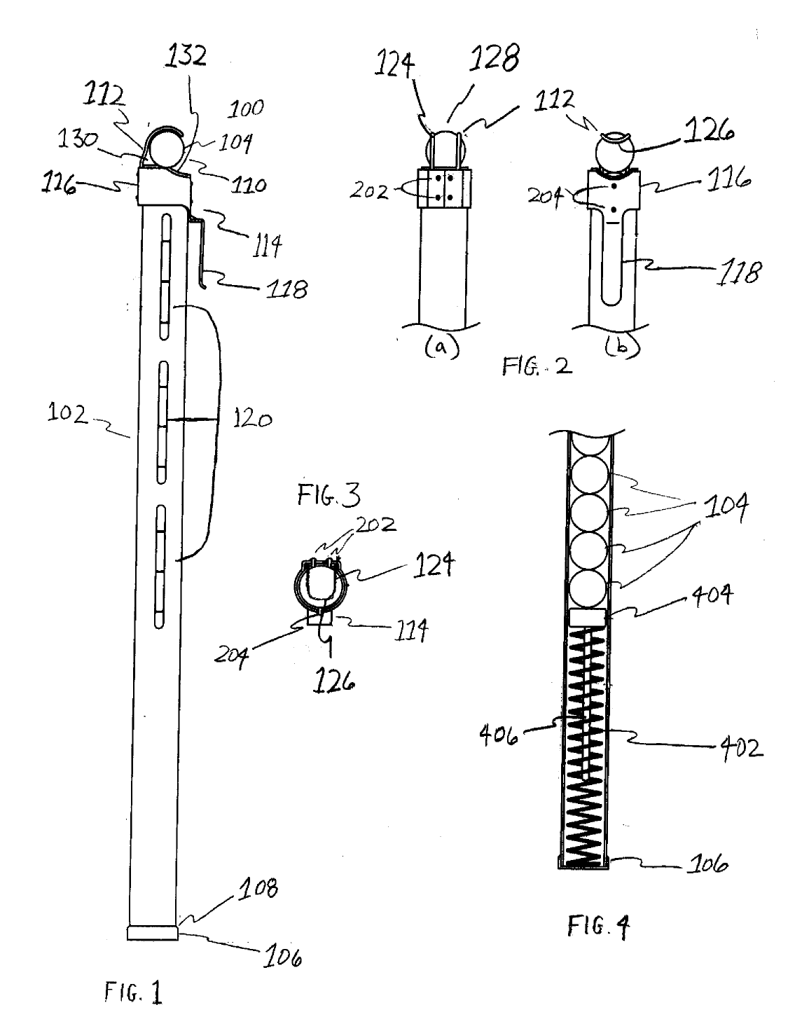

FIG. 1 depicts a side view of one embodiment of the golf ball dispenser 100 in accordance with the present invention. The device 100 includes an elongated housing 102 having a substantially cylindrical interior with diameter slightly larger than that of a conventional golf ball 104, a standard golf ball 104 having diameter of 1.68 inches. The elongated housing 102 is hollow so the interior space can hold a plurality of golf balls 104 in a stacked configuration therein. The elongated housing 102 has a threaded bottom that receives a cap 106 at the bottom end. The threaded bottom cap 106 can be unscrewed and removed from the golf ball dispenser 100 for cleaning and maintenance of the interior of the device 100. The threaded bottom cap 106 has a beveled shape 108 to prevent damage to the device 100 and to golf clubs and other contents of a golf bag 502 shown in FIG. 5 when the device 100 is inserted into or removed from the bag.

At the top end of the elongated housing 102 is an opening 110 for removal of a golf ball 104 and a wire ball catch 112. The wire ball catch 112 retains the topmost golf ball 104 in the stack of golf balls at the opening 110 for easy retrieval by a user. The wire ball catch 112 is durable and can be made of hard metal that will not bend or break if the golf ball dispenser 100 is contacted by golf clubs or dropped. The wire ball catch 112 can be covered with a plastic, rubber or other protective material coating so that the wire ball catch 112 does not scratch or damage the golf balls 104. The wire ball catch 112 has two wire ends 124 attached to the elongated housing 102 at distance slightly less than the width of a golf ball 104, between, for example, 1¼ inches and 1⅜ inches. The wire ends 124 of the wire ball catch 112 are curved to conform to the shape of a golf ball. The wire bends and extends over the top of the topmost golf ball 104 to form a retaining lip 126 for preventing the golf ball 104 from being ejected from the device 100 until the ball is manually removed. The retaining lip portion 126 may be flared around the surface of the ball 104 to better encircle and grip the ball 104. The wire ball catch 112 allows most of the surface of the topmost golf ball 104 to be visually inspected by the user for damage, scratches, or dirt to determine whether to discard the golf ball. 104.

The space 128 between the two wires 124 of the wire ball catch 112 is wide enough to allow a finger to displace the topmost golf ball 104 for removing the ball from the golf ball dispenser 100 through the opening 110. The wire ball catch 112 is spaced from the top rim of the elongated housing 102 to prevent the golf ball 104 from being ejected in any direction other than toward the opening 110, that is, the golf ball 104 is larger than the space between the top rim of the elongated housing 102 and the sides of the two wires 124. But, when a finger applies a downward and forward ejective force to the topmost ball 104, it forces the topmost ball 104 downward into the device 100 to compress the spring 402 until the ball moves into the curved lip 132 where it has sufficient clearance to exit the device 100. The golf ball 104 can be further guided or pulled by the user along the sides of the golf ball 104, which are fully accessible. The golf ball 104 pulls right into the user's palm. The removal of the golf ball 104 is easy enough to be done with one hand or two fingers. The wire ball catch 112 guides the ball downward into the lip 132.

Once the topmost golf ball 104 is removed, it creates space for another golf ball 104 to be pushed up by the spring 402 into the device 100 as the topmost golf ball 104. When the downward force is applied to the topmost ball 104 to allow for the insertion of another golf ball 104 into the device 100, the wire ball catch 112 and the interior walls of the substantially cylindrical interior of the elongated housing 102 guide the golf ball 104 down into the elongated housing 102 so that the golf ball 104 cannot exit from the sides. Though the lip 126 is curved downward in the preferred embodiment, it can be linear or be inversely curved to further guide the golf ball 104. In addition, the user can remove the golf ball 104 by placing a finger in the space 130 between the golf ball 104 and the back of the wire ball catch 112.

As shown in FIG. 2 and FIG. 3, the wire ball catch 112 is fastened to the elongated housing 102 by rivets 202. The elongated housing 102 has a bag clip 114 at the top end for securing the device to the rim of a golf bag 502 when inserted therein. The bag clip 114 has a sleeve portion 116 and a tab portion 118. The sleeve portion 116 wraps around the elongated housing 102 to fasten the bag clip 114 to the elongated housing 102. The sleeve portion 116 is fastened to the elongated housing rivets 202, 204 as shown in FIG. 2 and FIG. 3. In an alternative embodiment, the sleeve 116 may screw on to the top of the elongated housing 102 making the sleeve portion 116 and wire ball catch 112 removable. The tab portion 118 removably grips the rim of a golf bag when the device is placed inside the bag 502. In this manner, the user of the device can place the device inside his or her golf bag to easily transport the device and the balls contained therein.

Observation slots 120 are cut into the elongated housing 102 to allow visual inspection of the interior of the housing 102. The observation slots 120 extend along the longitudinal axis of the elongated housing 102. In particular, the number of golf balls 104 contained within the device is readily ascertainable.

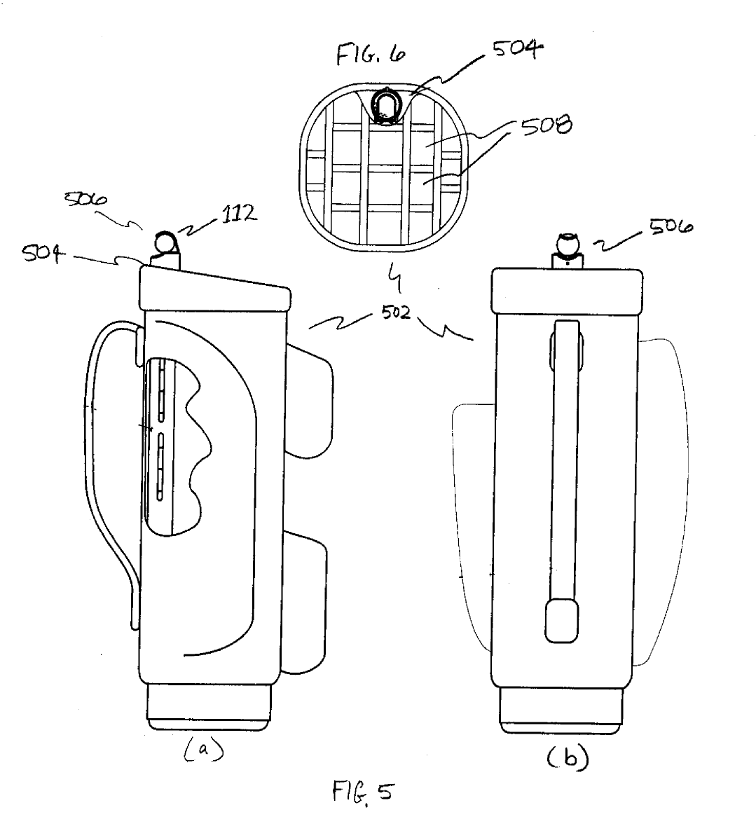

Turning now to FIG. 4, a spring 402 is provided in the interior of the cylindrical housing 102. The spring 402 presses against the bottom 106 of the device to apply an upward force to the plurality of vertically stacked golf balls 104 contained in the device 100. Thus, the spring 402 biases the stack of golf balls 104 toward the opening 110 and into the wire ball catch 112. A platform or pad 404 is provided at the top of the spring 402 to prevent damage to the bottommost golf ball 104. The spring 402 pushes against the pad 404 to apply upward force to the plurality of vertically stacked golf balls 104. The wire ball catch 112 maintains a ball at the opening 110 of the cylindrical housing 102 until a user of the device manually removes the ball 104 from the device. The upward force of the spring 402 then pushes the remaining balls toward the wire ball catch 112 and in doing so positions the next ball for manual removal. The removable bottom 106 can be removed from the device 100 to allow for cleaning and repair of the spring 402, the spring pad 404, and the spring stop 406.

When the device 100 contains no golf balls 104, a user may load a first golf ball 104 into the device 100 by inserting the golf ball 104 into the wire ball catch 112 such that the golf ball 104 is held in place by the wire ball catch 112 and the spring pad 404. The user may load additional golf balls 104 into the device 100 by applying a downward force to the topmost golf ball and inserting the additional golf ball into the wire ball catch 112 such that the additional golf ball is held in place by the wire ball catch 112 and the previously topmost golf ball. A spring stop 406 is attached to the spring pad 404 to prevent the spring 402 from being overly compressed by too many balls 104 or too much downward force applied by the user.

In another embodiment of the present device as shown in FIG. 5 and FIG. 6, a receptacle 504 is molded into a golf bag 502 to receive the golf ball dispenser 100. The receptacle 504 has an opening to slidably and removably receive the golf ball dispenser 100. The receptacle 504 makes it easy to insert the golf ball dispenser 100 into and remove the dispenser 100 out of a golf bag 502. When inserted into the receptacle 504, the dispenser 100 extends out of the top 506 for easy accessibility to the topmost golf ball 104. This configuration provides additional protection for golf clubs and other contents of the golf bag 502 that may come into contact with the golf ball dispenser 100. In addition, this embodiment eliminates the need for a bag clip 114. Alternatively, the dispenser 100 can be placed into one of the compartments 508 of the golf bag 502. The bag clip 114 may be also be attached to the golf bag 502 in combination with the receptacle 504 or when in one of the compartments 508 to provide supplemental stabilization of the device 100 in the golf bag 502. The bag clip 114 can also attach to other articles, such as a golf cart or golf bag holder.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. A golf ball dispensing and storing device comprising:
an elongated housing having an interior for receiving a plurality of golf balls in a linear configuration, the elongated housing having a first end and a second end opposite the first end;
a cap removably engaging the first end of the elongated housing to permit access to the housing interior;
a wire ball catch attached to the second end of the elongated housing for retaining a topmost golf ball of the plurality of golf balls at a position external to said interior;
a spring having a bottom end engaging the cap at the first end of the elongated housing and a top end providing an upward force toward the second end of the elongated housing, said spring also having a spring stop for preventing the spring from becoming overly compressed;
a spring pad engaging to the top end of the spring, said spring pad engaging a bottommost golf ball of the plurality of golf balls in a vertical configuration such that the upward force of the top end of the spring is applied to the bottom ball urging the plurality of golf balls toward the second end of the elongated housing; and
an opening at the second end of the elongated housing for removing the topmost ball from the device.

2. The golf ball dispensing and storing device as set forth in claim 1 wherein one or more vertical slots are cut into the elongated housing providing visual access to the interior of the device.

3. The golf ball dispensing and storing device as set forth in claim 1 wherein the cap removably attached to the first end of the elongated housing is a beveled, threaded cap.

4. The golf ball dispensing and storing device as set forth in claim 1 wherein said cap is threadably received on the first end of the elongated housing.

5. The golf ball dispensing and storing device as set forth in claim 1 wherein the wire ball catch attached to the second end of the elongated housing is fixedly attached to a sleeve, wherein the sleeve is threaded to removably engage the second end of the elongated housing.

6. The golf ball dispensing and storing device as set forth in claim 1 wherein the wire ball catch is curved to retain the topmost golf ball with minimal contact with the surface of the topmost ball and maximal accessibility to the topmost ball.

7. The golf ball dispensing and storing device as set forth in claim 1 wherein said wire ball catch is a wire prong.

8. The golf ball dispensing and storing device as set forth in claim 7 wherein said wire ball catch is flared to encircle the topmost golf ball so a finger may be placed therethrough to displace the topmost golf ball.

9. The golf ball dispensing and storing device as set forth in claim 1 further comprising a bag clip for removably attaching the device to inside a golf bag.

10. The golf ball dispensing and storing device as set forth in claim 1 further comprising a receptacle molded into the interior of a golf bag for slidably and removably receiving the elongated housing.

11. The golf ball dispensing and storing device as set forth in claim 1 wherein the wire ball catch has a protective material coating.

12. The golf ball dispensing and storing device as set forth in claim 11 wherein the protective material coating is one of plastic or rubber.

13. The golf ball dispensing and storing device as set forth in claim 1 wherein the elongated housing has a rim with a lip to permit removal of the topmost golf ball.

14. The golf ball dispensing and storing device as set forth in claim 9 wherein the bag clip is disposed on a side of the elongated housing that is the side at which a topmost golf ball is removed from the device.

15. The golf ball dispensing and storing device as set forth in claim 1 wherein the device is freestanding.

16. A golf ball dispensing and storing device comprising:
an elongated housing having an interior for receiving a plurality of golf balls in a linear configuration, the elongated housing having a first end and a second end opposite the first end;
a wire ball catch fixedly attached to the second end of the elongated housing for retaining a topmost golf ball of the plurality of golf balls at a position external to said interior;
a spring having a bottom end engaging the first end of the elongated housing and a top end providing an upward force toward the second end of the elongated housing, said spring also having a spring stop for preventing the spring from becoming overly compressed;
a spring pad engaging to the top end of the spring, said spring pad engaging a bottommost golf ball of the plurality of golf balls in a vertical configuration such that the upward force of the top end of the spring is applied to the bottom ball urging the plurality of golf balls toward the second end of the elongated housing; and
an opening at the second end of the elongated housing for removing the topmost ball from the device.

17. A golf ball dispensing and storing device comprising:
an elongated housing having an interior for receiving a plurality of golf balls in a linear configuration, the elongated housing having a first end and a second end opposite the first end;
a cap removably engaging the first end of the elongated housing to permit access to the housing interior;
a spring having a bottom end engaging the cap at the first end of the elongated housing and a top end providing an upward force toward the second end of the elongated housing, said spring also having a spring stop for preventing the spring from becoming overly compressed;
a spring pad engaging to the top end of the spring, said spring pad engaging a bottommost golf ball of the plurality of golf balls in a vertical configuration such that the upward force of the top end of the spring is applied to the bottom ball urging the plurality of golf balls toward the second end of the elongated housing; and
an opening at the second end.of the elongated housing for removing the topmost ball from the device.
